(19) United States
(12) Patent Application Publication
(10) Pub. No.: US 2015/0366192 A1
(43) Pub. Date: Dec. 24, 2015

(54) NON-TOXIC ANT-REPELLING GEL

(71) Applicant: Dennis Bruce Jenkins, Brentwood, CA (US)

(72) Inventor: Dennis Bruce Jenkins, Brentwood, CA (US)

(21) Appl. No.: 14/311,336

(22) Filed: Jun. 22, 2014

(51) Int. Cl. A01N 37/06; A01N 25/24; A01N 25/04; A01N 59/00

(52) U.S. Cl. CPC A01N 37/06; A01N 59/00; A01N 25/24; A01N 25/04

(57) ABSTRACT

A natural non-toxic ant-repelling gel is created by combining certain fatty acids with a thickening agent. The gel has the surprising ability to be used safely around food, children and pets, because it is derived from an edible source. The gel is applied to permanently block or repel ants. Since this is an oil-based gel composition, it is also long-lasting and water-proof, so it can be used outside. One particular use is to block the path of ants attempting to access a hummingbird feeder or nectar bird feeder.

### CROSS-REFERENCE TO RELATED APPLICATIONS

This application claims the benefit of Provisional Application 61/838,343, filed on Jun. 24, 2013, entitled “Non-Toxic Insect-Repelling Gel”, and is incorporated by reference herein in its entirety.

### BACKGROUND OF THE INVENTION

1. Field of the Invention

The present invention relates to a method, composition and kit for repelling ants, using natural non-toxic components. The present invention also relates to methods, compositions and kits, for blocking and repelling ants from accessing nectar bird feeders.

2. Background of the Related Art

For millenia, ants have been invading human foodstuffs and dwellings. Numerous strategies have been devised to kill or repel ants (U.S. Pat. No. 4,874,611, U.S. Pat. No. 5,589,181, U.S. Pat. No. 4,349,553, EP2230914B1). Most of the existing strategies are hazardous and pose a threat to humans, birds and animals. There is a benefit to the environment in reducing the use of insecticides, and developing non-toxic solutions for controlling insects. People also desire effective solutions that do not involve toxic chemicals or insect killing strategies, such as a non-toxic reagent which could repel, or keep ants from invading a particular area or object.

There is a special need to protect hummingbird nectar feeders and oriole nectar feeders from ants. Since ants are very attracted to sugar, they are strongly drawn to the sugar solutions within a hummingbird nectar feeder. Once the ants have discovered this food source, they are highly motivated, and will persist in overcoming obstacles to reach it. Any solution needs to be safe and non-toxic since it is in close contact to the birds and their food.

We have discovered a surprisingly effective method of repelling ants, using a compound that is so safe it can be used around food, pets, birds and children. The invention also provides a long lasting solution, since it relies on stable natural compounds, that remain effective for months.

There are physical devices which claim to be ant barriers (U.S. Pat. No. 7,793,461, U.S. Pat. No. 6,012,414), but they require purchasing and installing additional equipment. The current invention can be used directly on any existing feeder or feeder support, without additional equipment.

### SUMMARY OF THE INVENTION

By combining certain fatty acids, such as oleic acid, with a thickening agent we have discovered a natural non-toxic gel that has the surprisingly ability to strongly repel ants. This gel can be placed across access points to permanently repel and block ants. The reason that this formulation works so effectively is that ants sense by using chemical signals, and oleic acid is detected by ants as the smell of dead ants. To them it is as offensive as cadaverine and the smell of corpses is to humans. It therefore triggers their necrophobic instinct to flee. When ants detect the gel they literally run in the opposite direction, frantically clean themselves off, and abandon any attempt to enter the area again.

Since this is an oil-based gel composition, it is also long-lasting and water-proof, so it will endure outside exposure over long periods. One inventive use is to block the path of ants attempting to access a hummingbird feeder or nectar bird feeder. By drawing a thin line of gel around a supporting pole or hook, the invention is effective in permanently stopping ants from getting to the known sugar source of the nectar in hummingbird feeders. The ants will give up trying to penetrate the line of the repellent gel, and abandon the area. And it is safe enough to use around birds.

One example of the formula is an oleic acid combined with fumed silica to form a gel. The fumed silica is also a physical irritant to the ants and helps create a permanent physical and chemical barrier. Physical property testing reveals this gel has shear-thinning flow properties, so it can be easily applied yet stays in place on surfaces to create a natural chemical barrier that is impenetrable to ants. Stability testing shows that the gel is heat stable, and does not melt or lose shape up to 210 degrees F. Outside exposure testing shows that the repelling action of the composition lasted for more than a year, even when exposed to rain, frost, and heat (to 115 degrees F.).

A major advantage of this composition over other insect repelling compositions, is that it is completely safe to use around food, children, pets, and wild birds. This is because oleic acid is the primary component of edible oils such as canola or olive oil, so it is already universally consumed. And, fumed silica along with many other thickening agents are approved for use by the FDA as a food additives.

In one embodiment of the present invention, the composition is a fatty acid combined with a thickening agent, and optionally a functional additive, to form a non-toxic ant-repelling gel.

In one embodiment of the present invention, the composition is a fatty acid combined with a thickening agent, and optionally a functional additive, to form a non-toxic ant-repelling gel, used to protect wild bird nectar feeders from ants or insects.

In one embodiment of the present invention, the composition is a monounsaturated oil combined with a thickening agent to form a non-toxic ant-repelling gel.

In one embodiment of the present invention, the composition is oleic acid combined with a thickening agent to form a non-toxic ant-repelling gel.

In one embodiment of the present invention, the composition is oleic acid combined with a thickening agent, and optionally a functional additive, to form a non-toxic ant-repelling gel, used to protect wild bird nectar feeders from ants or insects.

In one embodiment of the non-toxic ant-repelling gel, the thickening agent is a high viscosity wax such as bee's wax.

In one embodiment of the non-toxic ant-repelling gel, the thickening agent is an oliophillic polymer.

In one embodiment of the non-toxic ant-repelling gel, the thickening agent is an oil-miscible gelling agent such as Carbopol (Lubrizol Corp).

In one embodiment of the non-toxic ant-repelling gel, the thickening agent is a clay.

In one embodiment of the non-toxic ant-repelling gel, the thickening agent is silicon dioxide.

In one embodiment of the non-toxic ant-repelling gel, the thickening agent is a silica selected from the group consisting of fumed silica, precipitated silica, silica gel, alpha quartz, diatomaceous earth, nano silica and combinations thereof.

In one embodiment of the non-toxic ant-repelling gel, the thickening agent is a clay.

In one embodiment of the non-toxic ant-repelling gel, the thickening agent has physical properties irritating to ants such as fumed silica, silica gel, precipitated silica, alpha quartz, diatomaceous earth, and combinations thereof.

In one embodiment of the non-toxic ant-repelling gel, the thickening agent is a silicone-treated fumed silica.

In one embodiment of the non-toxic ant-repelling gel, the composition is a fatty acid combined with a thickening agent, enclosed within packaging means.

In one embodiment of the present invention, the composition is a fatty acid combined with water and an emulsifying surfactant to form a non-toxic ant-repelling emulsion.

In one embodiment of the present invention, the composition is a fatty acid combined with water and an emulsifying surfactant to form a non-toxic ant-repelling emulsion used to protect wild bird nectar feeders from ants or insects.

In one embodiment of the present invention, the composition is a monounsaturated oil combined with water and an emulsifying surfactant to form a non-toxic ant-repelling emulsion.

In one embodiment of the present invention, the composition is oleic acid combined with water and an emulsifying surfactant to form a non-toxic ant-repelling emulsion.

In one embodiment of the present invention, the composition is oleic acid combined with water and an emulsifying surfactant to form a non-toxic ant-repelling emulsion used to protect wild bird nectar 100 feeders from ants or insects.

In one embodiment of the non-toxic ant-repelling emulsion, the emulsifier is a non-ionic surfactant.

In one embodiment of the non-toxic ant-repelling emulsion, the emulsifier is an anionic surfactant.

In one embodiment of the non-toxic ant-repelling emulsion, the emulsifier is a cationic surfactant.

In one embodiment of the non-toxic ant-repelling emulsion, the emulsifier is a combination of non-ionic, anionic, and cationic surfactants.

In one embodiment of the non-toxic ant-repelling emulsion, silica-based additives are added such as fumed silica, silica gel, precipitated silica, alpha quartz, diatomaceous earth, and combinations thereof.

In one embodiment of the non-toxic ant-repelling emulsion is enclosed within packaging means.

One embodiment of the present invention is a kit for repelling and blocking ants comprising: (i) a non-toxic ant-repelling gel, comprising: (a) a fatty acid, (b) a thickening agent to increase viscosity, (c) optionally, a functional additive; (ii) instruction means for applying said ant repelling gel.

One embodiment of the present invention is a kit for repelling and blocking ants from accessing a wild bird nectar feeder, comprising: (i) a non-toxic ant-repelling gel, comprising: (a) a fatty acid, (b) a thickening agent to increase viscosity, (c) optionally, a functional additive; and (ii) instruction means for applying said ant repelling gel.

One embodiment of the present invention is a kit for repelling and blocking ants from accessing a wild bird nectar feeder, comprising: (i) a non-toxic ant-repelling gel, comprising: (a) a fatty acid, (b) a thickening agent to increase viscosity, (c) optionally, a functional additive; (d) optionally, packaging means; and (ii) instruction means for applying said ant repelling gel.

One embodiment of the present invention is a kit for repelling and blocking ants from accessing a wild bird nectar feeder, comprising: (i) a non-toxic ant-repelling gel, comprising: (a) oleic acid, (b) a thickening agent to increase viscosity, (c) optionally, a functional additive; (d) optionally, packaging means; and (ii) instruction means for applying said ant repelling gel.

One embodiment of the present invention is a kit for repelling and blocking ants from accessing a wild bird nectar feeder, comprising: (i) a non-toxic ant-repelling gel, comprising: (a) oleic acid, (b) fumed silica, (c) optionally, a functional additive; (d) optionally, packaging means; and (ii) instruction means for applying said ant repelling gel.

One embodiment of the present invention is a kit for repelling and blocking ants, wherein the fatty acid is a monounsaturated oil.

One embodiment of the present invention is a kit for repelling and blocking ants, wherein the fatty acid is oleic acid.

One embodiment of the present invention is a kit for repelling and blocking ants, wherein the fatty acid is oleic acid, and is the primary component of a natural vegetable oil such as sunflower oil, olive oil, or canola oil.

One embodiment of the present invention is a kit for repelling and blocking ants, wherein the thickening agent is a selected from a group consisting of high viscosity wax, an oliophillic gelling agent, copolymers of acrylic acid, high surface area thickeners, clay, precipitated silica, diatomaceous earth, fumed silica, surface-treated fumed silica and combinations thereof.

One embodiment of the present invention is a kit for repelling and blocking ants, wherein the thickening agent also has physical properties irritating to ants such as fumed silica, silica gel, precipitated silica, alpha quartz, diatomaceous earth, and combinations thereof.

One embodiment of the present invention is a kit for repelling and blocking ants, wherein the thickening agent is fumed silica.

One embodiment of the present invention is a kit for repelling and blocking ants, comprising a non-toxic ant-repelling gel, dispensed through a syringe as a line of gel.

One embodiment of the present invention is a kit for repelling and blocking ants, wherein the packaging means is selected from a group consisting of a syringe, a flexible squeeze tube, a squeeze tube, a caulking gun, a paste dispenser, a can, a bottle, a spray bottle, a bag, a pouch, a packet, tube, and combinations thereof.

One embodiment of the present invention is a kit for repelling and blocking ants, wherein the packaging materials are selected from a group consisting of plastic, glass, metal foil, mylar, nylon, paper, and composite combinations thereof.

One embodiment of the present invention is a kit for repelling and blocking ants, comprising: (i) a non-toxic ant-repelling emulsion, comprising: (a) a fatty acid, (b) water, (c) an emulsifier, (d) optionally, a functional additive; (ii) instruction means for applying said ant repelling emulsion.

One embodiment of the present invention is a kit for repelling and blocking ants, comprising: (i) a non-toxic ant-repelling emulsion, comprising: (a) oleic acid, (b) water, (c) an emulsifier, (d) optionally, a functional additive; (e) packaging means (ii) instruction means for applying said ant repelling emulsion.

One embodiment of the present invention is a kit for repelling and blocking ants from accessing a wild bird nectar feeder, comprising: (i) a non-toxic ant-repelling emulsion, comprising: (a) oleic acid, (b) water, (c) an emulsifier, (d) optionally, a functional additive, (e) packaging means; (ii) instruction means for applying said ant repelling emulsion.

One embodiment of the present invention is a kit for repelling and blocking ants, comprising a non-toxic ant-repelling emulsion, wherein the fatty acid is a monounsaturated oil.

One embodiment of the present invention is a kit for repelling and blocking ants, comprising a non-toxic ant-repelling emulsion, wherein the fatty acid is oleic acid.

One embodiment of the present invention is a kit for repelling and blocking ants, comprising a non-toxic ant-repelling emulsion, wherein the fatty acid is oleic acid, and is the primary component of a natural vegetable oil such as sunflower oil, olive oil, or canola oil.

One embodiment of the present invention is a kit for repelling and blocking ants, comprising a non-toxic ant-repelling emulsion, dispensed as a spray though a spray bottle.

One embodiment of the present invention is a kit for repelling and blocking ants, comprising a non-toxic ant-repelling emulsion, within packaging means selected from a group consisting of a syringe, a squeeze tube, a caulking gun, a paste dispenser, a can, a jar, a bottle, a spray bottle, a bag, a pouch, a packet, and combinations thereof.

### DETAILED DESCRIPTION

### Fatty Acid

A fatty acid is a carboxylic acid with a long aliphatic tail (chain), which is either saturated or unsaturated.

### Monounsaturated Oil

A monounsaturated oil is a chemical compound that contains a single carbon-carbon double bond, such as those found in alkenes. Monounsaturated edible oils are non-toxic and considered a healthy oil alternative.

### Oleic Acid

Oleic acid is a fatty acid that occurs naturally in various animal and vegetable fats and oils. Oleic acid is classified as a monounsaturated omega-9 fatty acid. The term “oleic” means related to, or derived from, oil or olive, the oil that is predominantly composed of oleic acid.

Thickening agent

Thickening agents are additives which increase the viscosity of fluids. The mechanism of thickening can vary, and includes the flow-inhibiting properties of long polymers, high surface area material, high viscosity material or cross-linking agents. Examples include but are not limited to copolymers of acrylic acid (such as Carbopol™), natural gums, waxes, and polyacrylamide. Examples of high surface area materials are fumed silica, precipitated silica and clays, and create thickening by restricting the flow properties of the fluid. Clays can include but are not limited to montmorillonite, bentonite, kaolinite, fullers earth, or hectorite,

### Emulsifier

An emulsifier, is a substance that increasing the stability of an intimate blend of two or more immiscible phases. Emulsifiers are often also surfactants or “surface active agents. The surfactants employed in this invention can be anionic, cationic, non-ionic or combinations of each. Some examples of emulsifiers are cetearyl alcohol, polysorbate 20, and ceteareth 20.

### Functional Materials

Functional materials that may further be combined with the present inventive compositions include coloring agents and fragrance. Additional functional materials include, but are not limited to, anti-microbial agents, anti-molding agents, odor absorbers, rheology modifiers, spoilage indicators, and flavorants. The functional materials may be present in any desirable weight percent with respect to the ant repelling composition.

### Nectar Feeder

A wild bird nectar feeder is a device designed to dispense or display liquid food, giving access of the food to birds, especially hummingbirds and orioles. Examples of nectar feeders are inverted feeders and saucer feeders. An inverted feeder has a central reservoir that is suspended over the feeding ports and releases nectar from above. The effects of vacuum keep the nectar from flowing freely out the ports, keeping the ports filled at optimum levels. Inverted feeders can be top filling or bottom filling style. A saucer feeder is a simple dish filled with nectar that has ports above the reservoir, allowing birds to dip their bills into the nectar supply. A nectar feeder can be as simple as an inverted glass bottle with a tube at the bottom, or as complicated as a multiple feeding-port feeder. They all have in common a reservoir to hold the nectar, and feeding ports which restrict the free flow of the nectar out of the feeder while providing nectar access to the hummingbirds and orioles.

### Coloring Agent

A coloring agent may also be added to enhance the aesthetic nature of the ant blocking gel. However, a coloring agent is not necessary. Coloring agents include, but are not limited to dyes, pigments, and polymeric colorants. Non-limited examples of dyes include acid blue 9 dye, methylene blue, and wool violet. Examples of pigment are hematite, Cu-phthalocyanine or Ultramarine blue. Examples of polymeric colorants are various products under the Liquitint™ name produced by Milliken Chemical.

### Packaging Means

Suitable impermeable packaging means include, for example, but are not limited to containers of glass, plastic, foil, mylar, paper, waxed paper, and other materials known in the art for storing and dispensing liquid products. Other suitable impermeable packaging means include but are not limited to containers or film composed of polyvinylchloride (PVC), cellulose, cellophane, vinyl, nylon, thermoplastics, silicones, polyethylene, polypropylene, or combinations thereof. Suitable packaging means include, but are not limited to a syringe, a squeeze tube, a caulking gun, a paste dispenser, a can, a jar, a bottle, a spray bottle, a bag, a pouch, a packet, and combinations thereof.

### EXAMPLES

### Example 1

Ten grams of fumed silica (Cab-O-Sil, Cabot Corporation) are blended together with 140 grams of oleic acid. The fumed silica possesses a high surface area, and the oleic acid is a low viscosity fluid, and as the particles are dispersed in the oil they inhibit the free-flow of the oil. Simple mixing creates a thickening action that results in a clear gel.

Physical property testing reveals that the gel is shear-thinning, so it is easily applied, yet stays in place on surfaces. Testing shows that the gel is heat stable, and does not melt or lose shape up to 210 degrees F. The gel is also water-resistant, and therefore can stand up to the heat and rain outdoors.

The composition was tested via two applications methods on nectar feeders that had already been invaded by ants with a heavy ant trail: a) applying a thin line of gel around a hook holding a feeder and b) applying a thin line of gel on a pole supporting a feeder. Application resulted in immediate blocking of the ants, and no ant ever crossed the line again. Over time the gel thickens to become more waxy, but still repels ants. The repelling action of the composition and the protection of the feeders lasted for more than a year, exposed to rain, frost, and heat (to 115 degrees F.).

### Example 2

0.1 pounds of fumed silica (Cab-O-Sil, Cabot Corporation) is blended together with 1.5 pounds of oleic acid, and 0.001 pounds of cinnamon oil as a fragrance. A portion of the blend is placed into a syringe. The syringe is compressed to emit a line of gel around a pole supporting a nectar feeder.

I claim:

1. A non-toxic gel composition for repelling and blocking ants from wild bird nectar feeders, which comprises:
(a) oleic acid;
(b) a thickening agent to increase viscosity;
(c) optionally, a functional additive.

2. A composition of claim 1, wherein the oleic acid is the primary component of a vegetable oil selected from a group consisting of sunflower oil, olive oil, canola oil. corn oil, safflower oil, and combinations thereof.

3. A composition of claim 1 wherein the thickening agent is a selected from a group consisting of a high viscosity wax, an oliophillic gelling agent, a copolymer of acrylic acid, a high surface area material, a clay, precipitated silica, diatomaceous earth, fumed silica, and combinations thereof.

4. A composition of claim 1 wherein the thickening agent also has physical properties irritating to ants such as fumed silica, silica gel, precipitated silica, alpha quartz, diatomaceous earth, and combinations thereof.

5. A composition of claim 1 wherein the thickening agent is a fumed silica.

6. A composition of claim 1, wherein the functional additive is selected from the group consisting of colorants, anti-spoiling agents, fragrances, and mixtures thereof.

7. A composition of claim 1, enclosed within packaging means.

8. A kit for repelling and blocking ants from accessing a wild bird nectar feeder, comprising:
(i) a non-toxic ant-repelling gel, comprising:
(a) oleic acid;
(b) a thickening agent to increase viscosity;
(c) optionally, a functional additive;
(ii) instruction means for applying said ant repelling gel.

9. A kit of claim 8 wherein the oleic acid is the primary component of a vegetable oil selected from a group consisting of sunflower oil, olive oil, canola oil. corn oil, safflower oil, and combinations thereof.

10. A composition of claim 8 wherein the thickening agent is a selected from a group consisting of a high viscosity wax, an oliophillic gelling agent, a copolymer of acrylic acid, a high surface area material, a clay, precipitated silica, diatomaceous earth, fumed silica, and combinations thereof.

11. A kit of claim 8 wherein the thickening agent also has physical properties irritating to ants such as fumed silica, silica gel, precipitated silica, alpha quartz, diatomaceous earth, and combinations thereof.

12. A kit of claim 8 wherein the thickening agent is fumed silica.

13. A kit of claim 8 wherein the gel is enclosed within packaging means.

14. A kit of claim 8 wherein the gel is enclosed within packaging means selected from a group consisting of a syringe, a squeeze tube, a caulking gun, a paste dispenser, a can, a jar, a bottle, a spray bottle, a bag, a pouch, a packet, and combinations thereof.

15. A kit of claim 8 wherein the gel is packaged in a syringe, and dispensed as a line of gel.

16. A kit for repelling and blocking ants from accessing a wild bird nectar feeder, comprising:
(i) a non-toxic ant-repelling emulsion, comprising:
(a) oleic acid;
(b) water;
(c) an emulsifier;
(d) optionally, a functional additive;
(ii) instruction means for applying said ant repelling emulsion.

17. A kit of claim 16 wherein the oleic acid is the primary component of a vegetable oil selected from a group consisting of sunflower oil, olive oil, canola oil. corn oil, safflower oil, and combinations thereof.

18. A kit of claim 16 wherein the emulsion is enclosed within packaging means.

19. A kit of claim 16 wherein the emulsion is enclosed within packaging means selected from a group consisting of a syringe, a squeeze tube, a caulking gun, a paste dispenser, a can, a jar, a bottle, a spray bottle, a bag, a pouch, a packet, and combinations thereof.

20. A kit of claim 16 wherein the emulsion is packaged in a spray bottle, and dispensed as a spray.
